(19) United States
(12) Patent Application Publication
(10) Pub. No.: US 2021/0223776 A1
(43) Pub. Date: Jul. 22, 2021

(54) AUTONOMOUS VEHICLE WITH ON-BOARD NAVIGATION

(71) Applicant: Ati Motors Inc., Milpitas, CA (US)

(72) Inventors: Vinay Viswanathan, Bengaluru (IN); Naveen Arulselvan, Bengaluru (IN); Saurabh Chandra, Bengaluru (IN); Saad Nasser, Bengaluru (IN)

(73) Assignee: Ati Motors Inc., Milpitas, CA (US)

(21) Appl. No.: 17/155,050

(22) Filed: Jan. 21, 2021

(30) Foreign Application Priority Data
Jan. 22, 2020 (IN) 202041002880

(51) Int. Cl. G05D 1/02; G01S 17/931; G01S 17/42; G01C 21/00

(52) U.S. Cl. CPC G05D 1/024; G01S 17/931; G01C 21/3848; G05D 1/0274; G01S 17/42

(57) ABSTRACT

Implementations described herein relate to methods, systems, computer-readable media, and vehicles. In some implementations, a vehicle includes a light detection and ranging (LiDAR) sensor, a motor, and an on-board computer that includes a hardware processor and a memory. In some implementations, the memory includes instructions that cause the processor to perform scan of an environment using the LiDAR, determine a distance between the vehicle and one or more light reflecting objects in the environment for each LiDAR beam, perform a sliding window technique to identify one or more surfaces in the environment, detect one or more walls in the environment based on the one or more surfaces, and navigate the vehicle based on the detected one or more walls.

### RELATED APPLICATIONS

This application claims the benefit of Indian Non-Provisional Patent Application No. 202041002880, entitled “Autonomous Vehicle With On-board Navigation,” filed Jan. 22, 2020, which is incorporated by reference in its entirety.

### BACKGROUND

Autonomous vehicles are becoming popular in various environments, e.g., public streets, private roads or environments (e.g., golf courses, malls, warehouses), etc.

### SUMMARY

Some implementations described herein relate to methods, systems, computer-readable media, and vehicles. In some implementations, a vehicle includes a light detection and ranging (LiDAR) sensor, a motor, and an on-board computer that includes a hardware processor and a memory. In some implementations, the memory includes instructions that cause the processor to perform scan of an environment using the LiDAR, determine a distance between the vehicle and one or more light reflecting objects in the environment for each LiDAR beam, perform a sliding window technique to identify one or more surfaces in the environment, detect one or more walls in the environment based on the one or more surfaces, and navigate the vehicle based on the detected one or more walls.

In some implementations, a computer-implemented method to determine a distance between a LiDAR sensor and a light-reflecting object includes obtaining a plurality of readings (n) from a LiDAR sensor, wherein each reading includes a distance value (dᵢ) and an angle value (ϕᵢ). In some implementations, the distance value is indicative of a distance of the LiDAR sensor from the light-reflecting object and the angle value is indicative of an angle between a zero angle of the LiDAR sensor and an angle at which a LiDAR beam hits the light-reflecting object. The method further includes calculating a respective x-component (xᵢ) and a respective y-component (yᵢ) for each reading and calculating average of the x-components (x_hat) and average of the y-components (y_hat). The method further includes determining an x-vector (x′) wherein the x-vector has n components and wherein an ith component of the x-vector equals xᵢ−x_hat and determining a y-vector (y′) wherein the y-vector has n components and wherein an ith component of the y-vector equals yᵢ−y_hat. The method further includes determining a true angle (α) between the zero angle of the LiDAR sensor and the light-reflecting object by using the formula tan 2α−2x′^{T}y′/x′^{T}x′−y′^{T}y′. The method further includes determining a perpendicular distance (d) between the LiDAR sensor and the light-reflecting object by using the formula d=x_hat*cos α+y_hat*sin α. In some implementations, the LiDAR sensor emits the LiDAR beam at a fixed angle (θ) with a sweep angle (ϕ) of 360 degrees and wherein each reading is obtained 0.2 degrees apart from an immediately previous reading. In some implementations, the LiDAR sensor is part of a moving vehicle, and wherein the plurality of readings are obtained during movement of the vehicle. In some implementations, the plurality of readings are obtained in a time-period during which a distance covered by the vehicle is less than one-tenth of the perpendicular distance (d) between the LiDAR sensor and the light-reflecting object.

In some implementations, a method to calculate a distance between a vehicle and a vertical surface includes obtaining, using a LiDAR sensor mounted on the vehicle, a plurality of observations each comprising an estimated distance (dᵢ) between the vehicle and the vertical surface and an angle (ϕᵢ) of the LiDAR sensor. The method further includes calculating respective x (xᵢ) and y (yᵢ) components based on each of the plurality of observations. The method further includes calculating a mean value of the x and y components (x_hat and y_hat). The method further includes determining x and y vectors, wherein each vector has a plurality of components, each component corresponding to a respective observation of the plurality of observations. The method further includes calculating a true angle (α) between the LiDAR sensor and the vertical surface based on the x and y vectors. The method further includes calculating the distance (d) based on the true angle and the mean value of the x and y components respectively. In some implementations, the LiDAR sensor emits a LiDAR beam at a fixed angle (θ) with a sweep angle (ϕ) of 360 degrees and each observation is obtained 0.2 degrees apart from an immediately previous observation. In some implementations, the LiDAR sensor is part of a moving vehicle, and the plurality of observations are obtained during movement of the vehicle. In some implementations, the plurality of observations are obtained in a time-period during which a distance covered by the vehicle is less than one-tenth of the perpendicular distance (d) between the LiDAR sensor and the vertical surface.

In some implementations, a computer-implemented method includes performing scan of an environment using a plurality of beams of a LiDAR sensor on-board a vehicle. The method further includes determining, for each beam of the LiDAR, a distance between the vehicle and one or more light reflecting objects in the environment. The method further includes performing a sliding window technique to identify one or more surfaces in the environment. The method further includes detecting one or more walls in the environment based on the one or more surfaces and navigating the vehicle based on the detected one or more walls. In some implementations, the method further includes determining if a map of the environment is available. In these implementations, if it is determined that the map is available, the method further includes determining whether the one or more walls match the map. In these implementations, if it is determined that the one or more walls match the map, the method further includes determining a location of the vehicle in the environment, wherein navigating the vehicle is based on the location of the vehicle and a destination location, wherein the destination location is stored in the map. In some implementations, if it is determined that the one or more walls do not match the map, the method further includes updating the map to the add the one or more walls to the map. In some implementations, if it is determined that the map of the environment is not available, the method further includes updating the map to the add the one or more walls to the map. In some implementations, navigating the vehicle comprises guiding movement the vehicle to avoid the one or more walls.

In some implementations, a vehicle includes a light detection and ranging (LiDAR) sensor, a motor, and an on-board computer coupled to the LiDAR sensor and configured to control the motor. In some implementations, the on-board computer a hardware processor and a memory with instructions stored thereon that, when executed by the hardware processor, cause the hardware processor to perform operations that include performing scan of an environment using a plurality of beams of the LiDAR sensor; determining, for each beam of the LiDAR, a distance between the vehicle and one or more light reflecting objects in the environment; performing a sliding window technique to identify one or more surfaces in the environment; detecting one or more walls in the environment based on the one or more surfaces; and navigating the vehicle based on the detected one or more walls. In some implementations, the operations further include determining if a map of the environment is available. In these implementations, if it is determined that the map is available, the operations further include determining whether the one or more walls match the map. In these implementations, if it is determined that the one or more walls match the map, the operations further include determining a location of the vehicle in the environment, wherein navigating the vehicle is based on the location of the vehicle and a destination location, wherein the destination location is stored in the map. In some implementations, if it is determined that the one or more walls do not match the map, the operations further include updating the map to the add the one or more walls to the map. In some implementations, if it is determined that the map of the environment is not available, the operations further include updating the map to the add the one or more walls to the map. In some implementations, navigating the vehicle includes guiding movement the vehicle to avoid the one or more walls.

### BRIEF DESCRIPTION OF THE DRAWINGS

FIGS. 1A and 1B illustrate an example self-driving vehicle, in accordance with one or more implementations described herein.

FIG. 2 illustrates an example of a wheel which may be used as a rear wheel of a self-driving vehicle, in accordance with one or more implementations described herein.

FIGS. 3A and 3B illustrate different views of an example of a wheel 302 with a modular drive train which may be used for a self-driving vehicle, in accordance with one or more implementations described herein.

FIG. 4A illustrates an example of a self-driving vehicle with a swappable battery, in accordance with one or more implementations described herein.

FIG. 4B illustrates another example of a self-driving vehicle with a swappable battery, in accordance with one or more implementations described herein.

FIG. 5A illustrates a schematic top view of an environment 500.

FIG. 5B illustrates a side view 510 of a LiDAR beam hitting a wall, according to some implementations.

FIG. 6 illustrates an example method to calculate the shortest distance between a vehicle and a light-reflecting object such as a wall or other solid obstacle.

FIG. 7A illustrates an example environment in which a vehicle is located.

FIG. 7B shows a beam profile obtained during a complete sweep of a single beam from a LiDAR of a vehicle.

FIG. 7C shows reconstructed walls based on data from an on-board LiDAR of a vehicle.

FIG. 8A illustrates a vehicle at a known reference location in an environment.

FIG. 8B shows vehicle 804 which is located at an unknown location in an environment.

FIG. 8C illustrates an environment showing translation of vehicle where the vehicle is not in a reference location but the zero direction of the LiDAR is the same as the reference location.

FIG. 8D illustrates an environment showing rotation of the vehicle where the vehicle is in the reference location, but the zero direction of the LiDAR is different.

FIGS. 9A-9D illustrate the determination of vehicle pose.

FIGS. 10A and 10B illustrate the determination of vehicle pose for a stationary vehicle and FIGS. 10C and 10D illustrate the determination of vehicle pose for a moving vehicle by taking into account motion of the vehicle during a single LiDAR frame.

FIG. 11 illustrates an example method to determine the location of a vehicle and navigate the vehicle to a destination.

FIG. 12 is a block diagram of an example computing device 1200 which may be used to implement one or more features described herein.

### DETAILED DESCRIPTION

Self-driving vehicles offer many advantages—reduction in expense owing to saving labor costs; suitability for operation in tight spaces where conventional, manually-driven vehicles cannot operate; flexibility in design of shape; etc. Self-driving vehicles can operate in both indoor and outdoor environments.

Some implementations described herein relate to methods, systems, and non-transitory computer-readable media for autonomous navigation of a vehicle. In some implementations, a vehicle as described herein can achieve autonomous movement in limited mapped environments such as private industrial spaces, warehouses, etc. In some implementations, data from sensors such as a light detection and ranging sensor (LiDAR) and one or more other sensors such as a camera, inertial measurement unit (IMU), wheel encoders, etc. are used to accurately detect a location of the vehicle in an environment with reference to a map, to detect one or more walls in the environment, and to navigate the vehicle in the environment, e.g., toward a destination.

In some implementations, walls or other light-reflecting objects within the environment are used as external landmarks, eliminating the need to create or maintain artificial landmarks. The described techniques utilize the presence of fixed flat surfaces such as walls that are commonplace in many private spaces to determine location (position and orientation) of an autonomous vehicle in an environment. Per the described techniques, it is not necessary that such external landmarks be detected at all times; rather, such landmarks can be used when available.

In some implementations, navigation of the vehicle is performed taking into account noise in LiDAR measurement as well as measurement of motion of the vehicle. One technique to correct for drift due to noise is to construct a map of the environment and by determining the location of the vehicle based on the detected walls, e.g., two or more walls that are not necessarily orthogonal and whose positions are known on the map. This localization can be used to recalibrate the vehicle position. Further, in an unknown environment (where no prior map is available), the walls are detected dynamically. Wall detection can include determining dimensions (length and width) of the wall, identifying openings (e.g., windows), and a distance from the wall to the vehicle. The detection of the wall is made robust by combining data from multiple LiDAR beams, each with a corresponding angle, and by using data from multiple LiDAR frames. In some implementations, successful detection of two walls enables autonomous navigation of the vehicle by discovering new walls as the vehicle moves in the environment. Use of multiple detected walls in determining vehicle location makes the location robust to sensor noise. In some implementations, fusion may be used to combine data from multiple different estimates of the vehicle of the location. For example, a Kalman filter, such as Extended Kalman Filter or Unscented Kalman Filter, can be used to obtain a reduction in variance.

Some implementations described herein relate to a self-driving vehicle. In some implementations, the self-driving vehicle may have a front portion that carries a motor, navigation sensors (e.g., LiDAR), accelerometer and other sensors, an on-board processor coupled to memory and storage, and other components. In some implementations, the self-driving vehicle may have a modular drive train. In some implementations, the self-driving vehicle may be powered by a battery. In some implementations, the battery may be swappable.

In some implementations, the self-driving vehicle may utilize measurements from a LiDAR to determine a shortest distance to various light reflecting objects (walls) in the environment. In some implementations, based on observed points, walls in the environment may be identified. In some implementations, a map or a geo-referenced database of the environment may be generated based on the identified walls and distances. For example, the map may be constructed by detecting walls in an initial run of the self-driving vehicle in the environment. In some implementations, the map may be in two dimensions, e.g., an x-y map. In some implementations, multiple 2D maps may be constructed, e.g., where each map corresponds to a particular LiDAR beam, and may be utilized to construct a multi-beam map. In some implementations, e.g., when the environment undergoes changes over a period of time, the map may be updated based on new observations from the vehicle as it navigates in the environment.

In some implementations, a pose (including location and direction) of the self-driving vehicle in an environment may be determined. In some implementations, the location may be determined based on the map. In some implementations, e.g., when no stored map is available, the self-driving vehicle may determine its location relative to detected walls and track walls in the environment as it moves. In some implementations, the self-driving vehicle may identify and/or store locations associated with one or more charging points, battery swap locations, loading bays, unloading bays, maintenance locations, etc. and navigate to the locations. Navigation may be based on determining the pose of the vehicle and comparing it with the target location.

In some implementations, e.g., when vehicle movement during a particular LiDAR frame is greater than a threshold, compensation for the motion may be performed when detecting walls and determining distances. In some implementations, a Kalman filter may be used to filter LiDAR measurements prior to distance computation.

In some implementations, a sleep mode may be provided for the self-driving vehicle. In the sleep mode, the vehicle may analyze a subset of LiDAR frames, e.g., 1 frame every t seconds, to save energy and computational cost. For example, the sleep mode may be enabled when the vehicle is detected to be idle (stationary).

In some implementations, a smart driving mode may be provided for the self-driving vehicle. In this mode, the trajectory of the vehicle may be determined ahead of time, e.g., based on a destination, and LiDAR frames may be predicted. The prediction may be used to determine a cone of interest. A binary mask determined based on the cone of interest may be applied to the LiDAR readings in the next frame, and a subset of the readings that match the cone may be processed for wall detection, distance computation, pose determination, etc. while other LiDAR readings are discarded. The smart driving mode may save computational cost and may enable faster computation.

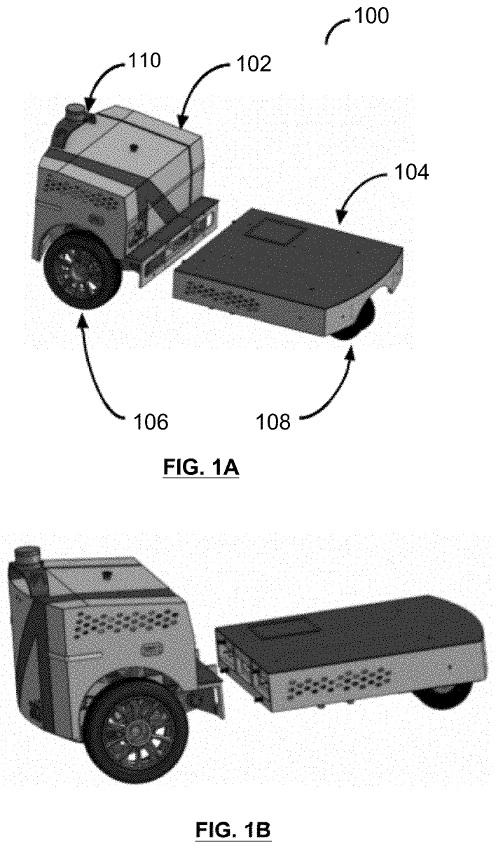

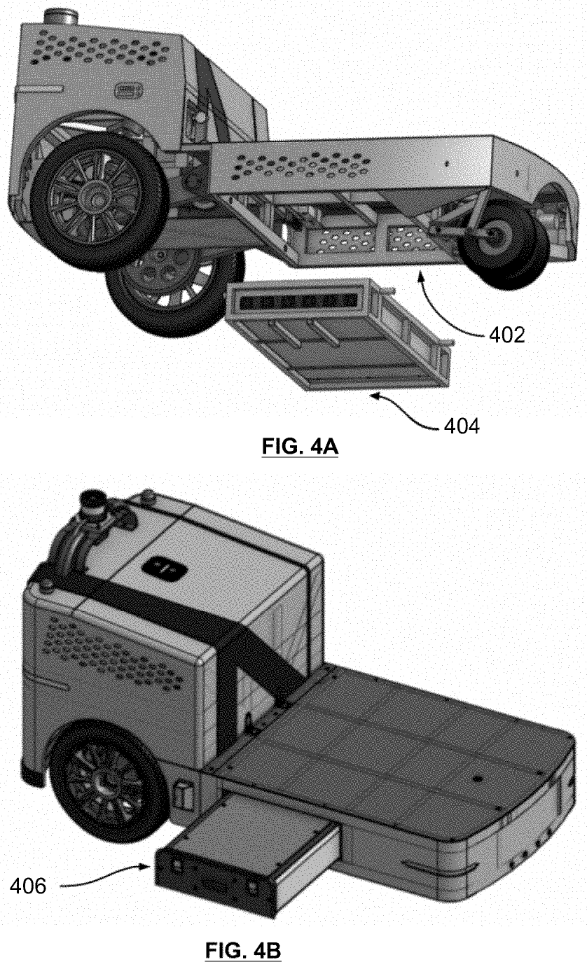

FIGS. 1A and 1B illustrates an example self-driving vehicle 100, in accordance with one or more implementations described herein. In some implementations, vehicle 100 has two parts—a front hub (102) and a load-carrying bed (104). Load-carrying bed 104 can be mechanically coupled to front hub 102. The split (split chassis) design that allows separation of front hub 102 and load-carrying bed 104 can facilitate transportation of vehicle 100. For example, front hub 102 and load-carrying bed 104 can be decoupled into separate parts, as illustrated in FIG. 1B. Further, in some implementations, load-carrying bed 104 may include a swappable battery that can be removed prior to transportation. An example swappable battery configuration is described with reference to FIG. 4. In some implementations, vehicle 100 may be configured with front hub 102 and load carrying bed 104 that are not separable.

Vehicle 100 is three-wheeled, with two front wheels (106) that are coupled to front hub 102 and a single rear wheel (108) that is coupled to load-carrying bed 104. Wheels 106 and 108 can be removed/replaced separately from front hub 102 and load-carrying bed 104. Front wheels 106 are independently powered by individual motors. Differential speeds of front wheels 106 provides steering action for vehicle 100.

Rear wheel 108 acts as an active castor wheel. Direction of rear wheel 108 is controlled using a motor (not shown). Rear wheel 108 is assembled such that the wheel can turn up to 90 degrees, which enables vehicle 100 to turn in place (zero turning radius). In some implementations, wheels 106 and 108 each have an independent suspension, which allows vehicle 100 to navigate varied terrains, e.g., terrains with varying slope, uneven terrains, etc.

Front hub 104 includes a top-mounted LiDAR (Light Detection and Ranging) sensor 110. In some implementations, LiDAR 110 may be configured such that it can emit a plurality of light beams (e.g., 16 beams) with different angles, e.g., one beam parallel to the ground, and a plurality of beams with a higher or lower angle. In some implementations, vehicle 100 may also include an on-board computer, having a hardware processor coupled to memory (and optionally, a storage device). The on-board computer may be coupled to LiDAR 110 and may control the operation of LiDAR 110. The on-board computer may operate LiDAR 110 to sense the environment that vehicle 100 operates in, e.g., the presence of obstacles, distance from obstacles, etc. The on-board computer may be configured, e.g., via instructions stored in the memory and/or a storage device, to determine a current location of the vehicle in the environment, detect obstacles (e.g., walls or other solid objects) and distance to the obstacles, and to navigate the vehicle to a particular location, e.g., a charging port, a loading/unloading station, a battery swapping port, or other location in the environment.

In some implementations, vehicle 100 may include other sensors such as weight sensor, velocity sensor, light sensor, heat sensor, global positioning sensor (GPS), etc. These additional sensors may be configured to communicate with the on-board computer. In some implementations, vehicle 100 may also include on-board communication hardware such as WiFi, Bluetooth, Cellular, etc. In some implementations, the on-board computer may communicate to one or more other computers via the on-board communication hardware, e.g., to receive updated configuration or instructions, to receive commands related to navigation in the environment, etc.

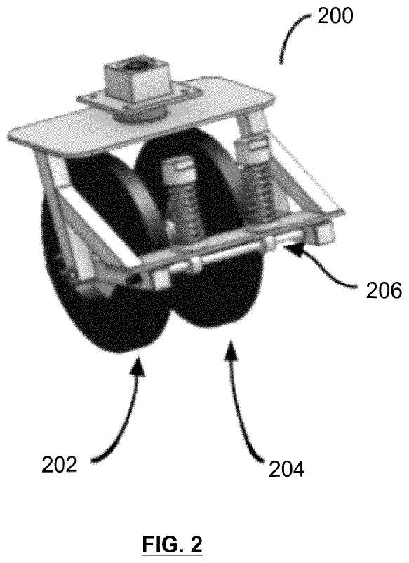

FIG. 2 illustrates an example of a wheel 200 which may be used as a rear wheel of a self-driving vehicle, in accordance with one or more implementations described herein. As seen in FIG. 2, wheel 200 is a dual wheel configuration with individual wheels 202 and 204. The dual wheel configuration of vehicle 100 allows vehicle 100 to turn with lower torque. Having two wheels (with tyres mounted thereon) converts sliding friction (which occurs in case of a single wheel) to rolling friction, thus bringing down the resistance.

Another benefit of the dual-wheel configuration is the strength of the tyre. In some implementations, tyres of small size (10-inch diameter) that have a loading capacity of 150-200 kilos can be used for wheels 202 and 204 of wheel 200. This enables wheel 200 to carry a load of up to twice the weight in comparison to single wheel configurations that use a single tyre of similar specification. In some implementations, wheel 200 also includes suspension 206 that reduces transverse movement of the wheel while withstanding impact loads.

In some implementations, the rear wheel is actively controlled to align with the front differential drive. The rear angle is set to a value equal to arctan(wheel_base/r) where r is the instantaneous radius of curvature. For example, when the vehicle is going straight, this angle is set to 90 degrees

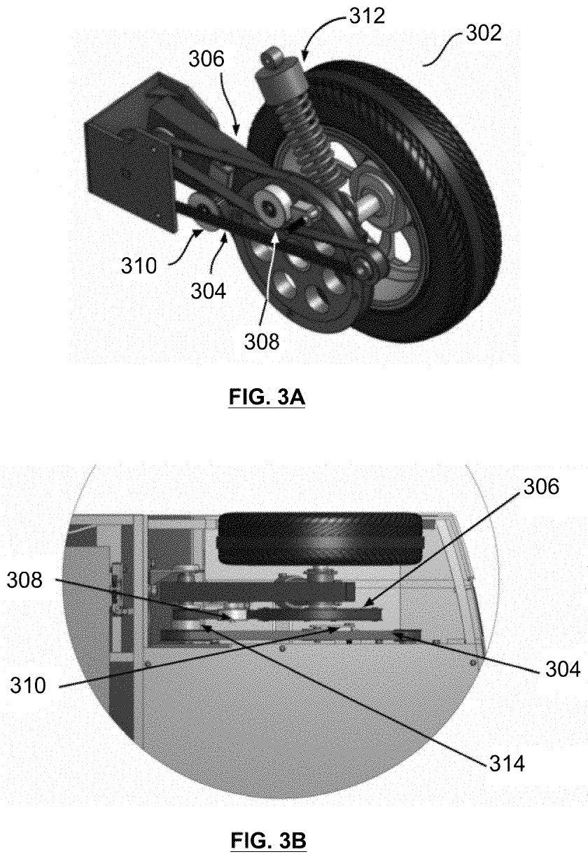

FIGS. 3A and 3B illustrate different views of an example of a wheel 302 with a modular drive train which may be used for a self-driving vehicle, in accordance with one or more implementations described herein. Wheel 302 includes a first stage belt 304 and a second stage belt 306. Wheel 302 further includes a first stage idler 308 and a second stage idler 310. Wheel 312 also includes suspension 312. Wheel 302 also includes a double stage pulley 314 for belts 304 and 306.

The modular drive train can reduce the time of maintenance and repair of the vehicle. In some implementations, the first stage (308) has a reduction of 1:2 and the second stage (310) has a reduction of 1:5, totaling at a 1:10 ratio of speed from the power source, e.g., motor (not shown), to the wheel. Two timing belts (304 and 306) can be used in order to reduce the slip on the pulley (314). The stages together can withstand a rater power of over 4 kW. In case of repair, such as the snapping of a belt, the drivetrain module can be removed and replaced with another by changing four bolts reducing the time for both repair and assembly.

FIG. 4A illustrates an example of a self-driving vehicle with a swappable battery, in accordance with one or more implementations described herein. As seen in FIG. 4A, a vehicle (e.g., a self-driving vehicle 100 as shown in FIG. 1) includes (or is coupled to) a load-carrying bed. In some implementations, a receiving port 402 is provided underneath the load-carrying bed. A swappable battery 404 can be coupled to the port and can provide power to the vehicle.

FIG. 4B illustrates another example of a self-driving vehicle with a swappable battery, in accordance with one or more implementations described herein. As seen in FIG. 4B, a vehicle (e.g., a self-driving vehicle 100 as shown in FIG. 1) includes (or is coupled to) a load-carrying bed. In some implementations, a receiving port is provided on one side of the load-carrying bed. A swappable battery 406 can be coupled to the port and can provide power to the vehicle.

When the battery is not swappable, a vehicle needs to be taken out of service for charging. For example, the downtime required to charge a vehicle with a 7 kWh battery can exceed 2 hours. The swappable battery configuration, as shown in FIG. 4A or 4B, can reduce the downtime significantly, e.g., two minutes.

In some implementations, the compartment of the battery is held by four two-staged rotary latches (as seen in FIG. 4B) for a firm grip. Each latch is mechanically linked to the other latches, such that the latches are all released at the same time. With the reduced downtime enabled by the use of a swappable battery, a smaller battery can be used. A smaller battery can reduce the weight of the vehicle, and can improve its energy efficiency.

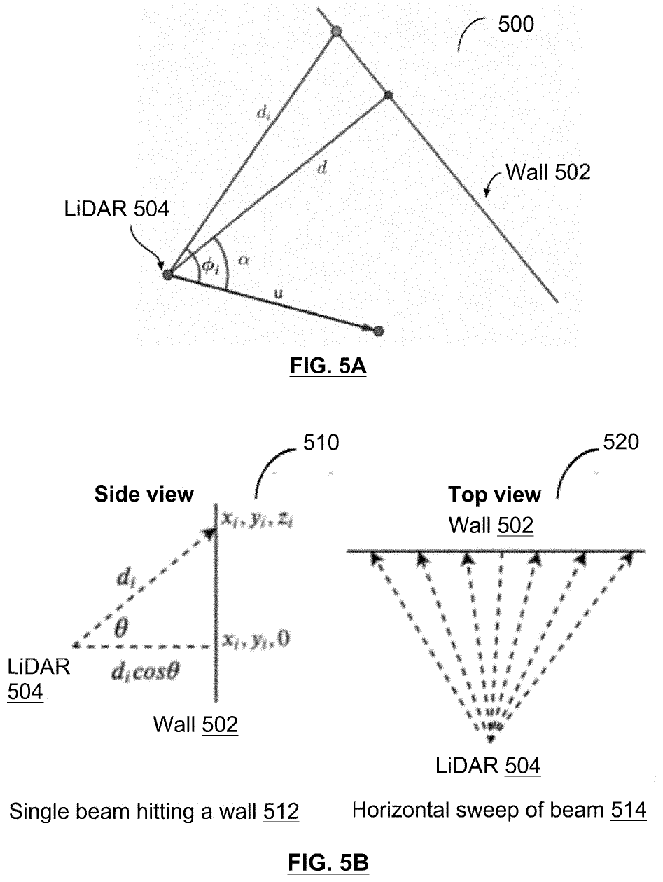

FIG. 5A illustrates a schematic top view of an environment 500. Environment 500 includes a wall 502 and Light Detection and Ranging sensor (LiDAR) 504. In some implementations, LiDAR 504 may be mounted on a vehicle.

As can be seen in FIG. 5A, wall 502 is in front of LiDAR 504. To automatically navigate the vehicle in environment 500, perpendicular (shortest) distance d of LiDAR 504 from wall 502 is to be determined, along with angle α between a zero angle of the LiDAR 504 (illustrated as the direction u) and wall 502. Further, walls (solid, impenetrable surfaces) need to be distinguished from other features in the environment.

The distance to be determined d, can be stated as:

|d=dᵢ cos(ϕᵢ−α)

where ϕᵢ is the angle between a beam of the vehicle LiDAR and wall 502 (angle in the plane of motion, also referred to as horizontal angle). Since the LiDAR has many beams that are incident on the wall at different vertical angles, n pairs of values (dᵢ,ϕᵢ) are obtained at vehicle 504 for values of i=1, 2, 3, . . . , n. The values can be used to obtain a robust estimation of d and α by minimizing a loss function L defined as follows:

L=Σ(d−dᵢ cos(ϕᵢ−α))² (I)

To minimize L and obtain the values of d and α, first set ∂L/∂d=0. The resultant equation is

$$2 {\sum }_{i = 0}^{n} ( d - {d}_{i} cos ( {φ}_{i} - α ) ) = 0$$

Rearranging the terms,

$$d = \frac{{\sum }_{i} d - {d}_{i} cos ( {φ}_{i} - α )}{n}$$

Expanding dᵢ cos(ϕᵢ−α) gives

dᵢ cos(ϕᵢ−α)=dᵢ cos ϕᵢ cos α+dᵢ sin ϕᵢ sin α

This in turn gives

d=\hat{x} cos α+ŷ sin α

where \hat{x} also referred to as x_hat, and ŷ also referred to as y_hat, are mean values given by the formulae:

$$\begin{matrix}\hat{ϰ} = \frac{1}{n} {\sum }_{j} {d}_{i} cos {φ}_{i} & ( II \text{-} A ) \\ \hat{y} = \frac{1}{n} {\sum }_{j} {d}_{i} sin {φ}_{i} & ( II \text{-} B )\end{matrix}$$

Taking xᵢ=dᵢ cos ϕᵢ and yᵢ=dᵢ sin ϕᵢ the cost function can be rewritten as:

$$L = {\sum }_{i} {( ( {x}_{i} - \hat{x} ) cos α + ( {y}_{i} - \hat{y} ) sin α )}^{2}$$

Substituting

xᵢ′=xᵢ−\hat{x} (III)

and similarly, y′ᵢ, L can be rewritten as:

$$L = {\sum }_{i} {( {x}_{i}^{′} cos α + {y}_{i}^{′} sin α )}^{2}$$

To find the value of α that minimizes the loss function, differentiating the loss function L with respect to α and setting it to zero gives:

$${\sum }_{i} ( {x}_{i}^{′} cos α + {y}_{i}^{′} sin α ) ( - {x}_{i}^{′} sin α + {y}_{i}^{′} cos α ) = 0$$

Multiplying the terms gives:

$${\sum }_{i} - {x}_{i}^{′2} sin αcos α - {x}_{i}^{′} {y}_{i}^{′} {sin}^{2} α + {x}_{i}^{′} {y}_{i}^{′} {cos}^{2} α + {y}_{i}^{′2} sin αcos α = 0$$

Grouping like terms gives:

$${\sum }_{i} ( {y}_{i}^{′2} - {x}_{i}^{′2} ) sin α cos α + {x}_{i}^{′} {y}_{i}^{′} ( {cos}^{2} α - {sin}^{2} α ) = 0$$

Using sin 2α=2 sin α cos α and cos 2α=cos 2α−sin² α

$${\sum }_{i} {x}_{i}^{′} {y}_{i}^{′} cos 2 α + \frac{1}{2} {\sum }_{i} ( {y}_{i}^{′2} - {x}_{i}^{′2} ) sin 2 α = 0$$

Rearranging the terms:

$$tan 2 α = \frac{2 \sum {x}_{i}^{′} {y}_{i}^{′}}{{\sum }_{i} {x}_{i}^{′2} - {y}_{i}^{′2}}$$

Introducing a vector x′ whose ith component is

xᵢ′=xᵢ−\hat{x}

and similarly, y′, the above formula for tan 2α can be rewritten in compact form as:

$$tan 2 α = \frac{2 {x}_{i}^{′ T} {y}_{i}^{′}}{{x}^{′ T} {x}^{′} - {y}_{i}^{′ T} {y}^{′}} \qquad ( IV )$$

This equation is a closed form for α and can be used to obtain the value of d. The distance d can then be calculated as:

d=\hat{x} cos α+ŷ sin α (V)

The LiDAR of vehicle 504 has multiple beams. each with a known angle θⱼ to the horizontal. For each fixed angle θⱼ, the LiDAR makes a complete 360 degree sweep at a preset resolution, e.g., a resolution of about 0.2 degrees. This results in about 1800 points per beam in a complete sweep. In some implementations, a complete sweep takes about 100 milliseconds. This information is obtained in chunks, each with a respective timestamp. Depending on the speed of the vehicle, the distance d may change during the sweep, e.g., by a few centimeters. For example, if the vehicle moves 20 centimeters during the course of a complete sweep of the beam, each centimeter of movement would correspond to an 18 degrees arc of the sweep.

In some implementations, e.g., when the distance d is several meters and/or LiDAR sensor has a tolerance of up to several centimeters, the effect of movement of the vehicle can be ignored for purposes of computation. In these implementations, the timestamp for all values obtained during a single beam sweep is set to the same value. This provides a technical benefit of eliminating computations to correct for the LiDAR readings. For example, this type of computation may be suitable when the distances between the vehicle and walls in the environment are known to be large and correspondingly, an error of a few centimeters in the vehicles positioning and the corresponding impact on navigation is tolerable.

In some implementations, e.g., when the vehicle needs to be positioned precisely, e.g., to dock with a receiving bay, to align with a charging unit, to navigate into a tight space, etc., a more precise measurement of d can be obtained.

The LiDAR output is a triple of the form (dᵢ, ϕᵢ, θ), where the beam with angle θ to the horizontal, and a sweep angle ϕᵢ returns a distance d indicating there is an obstruction at that distance. This triple can be replaced by (dᵢ cos θ, ϕᵢ). Data from multiple beams of the LiDAR can be processed in this manner.

In some implementations, all beams of the LiDAR can be processed. For example, this is important in an environment where one beam hits a wall but another beam (with a different angle to the horizontal) with the same sweep angle goes through, e.g., a window or other opening and hit an entirely different object. In some implementations, e.g., when it is known that the environment is comprised of regular walls (e.g., warehouses, data centers, other enclosed environments), data from one or more beams of the LiDAR may be omitted from computation, thus saving computational costs.

Data for certain beams is omitted, based on the environment. For example, data from top beams (oriented towards the ceiling) can be used and other data discarded in environments such as factories that have high ceilings. In another example, data from middle beams can be used for indoor environments with relatively short ceilings, and data from other beams can be discard. In yet another example, bottom beams can be used in environments with higher clutter, e.g., factory or warehouse floors, with data from other beams being discarded.

For example, a triple (10, 30, 5) output by the LiDAR indicates that a beam with an angle of 5 degrees to the horizontal and at a sweep angle of 30 degrees has hit an obstacle at a distance of 10 meters (dᵢ). The shortest distance d to the obstacle can then be obtained as 9.961 meters, based on this observation.

FIG. 5B illustrates a side view 510 of a LiDAR beam hitting a wall, according to some implementations. As can be seen in FIG. 5B, a beam that originates from a LiDAR 504 with an angle θ hits wall 502 at a point (xᵢ, yᵢ, zᵢ). The direct distance between the LiDAR and the wall is dᵢ. The perpendicular distance between wall 502—between the point (xᵢ, yᵢ, 0) and LiDAR 504 is then given by dᵢ cos θ.

FIG. 5C illustrates a top view 520 of a LiDAR beam hitting a wall, according to some implementations. As can be seen in FIG. 5C, the beam originating at LiDAR 504 performs a horizontal sweep, scanning through multiple angles ϕᵢ corresponding to different values of i. The beam thus hits wall 502 at different points, each producing its own reading.

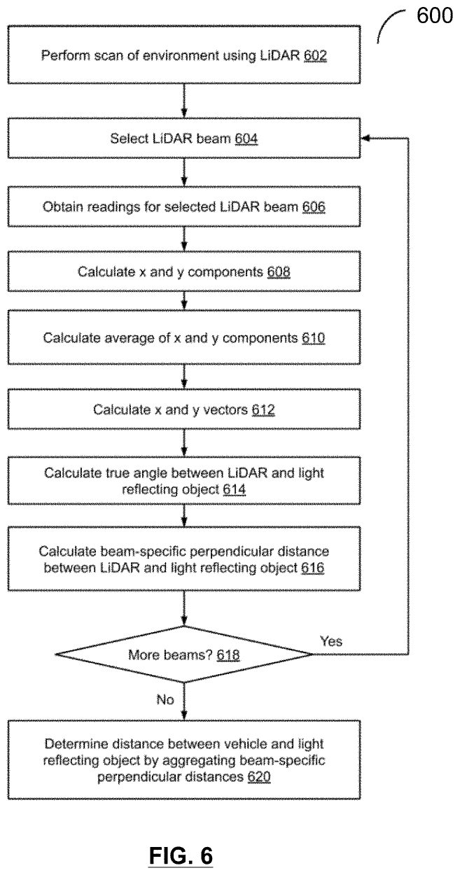

FIG. 6 illustrates an example method 600 to calculate the shortest distance between a vehicle and a light-reflecting object such as a wall or other solid obstacle.

Method 600 begins at block 602 where a LiDAR sensor on-board a vehicle is activated to perform a scan of the environment using a plurality of light beams, e.g., 16 beams. In some implementations, the plurality of light beams may span a total angle of 30 degrees. For example, the LiDAR sensor may be mounted at the top of a vehicle. The plurality of light beams may each have a respective angle with respect to the ground. Each beam may be rotated to perform a scan of the surroundings of the vehicle, e.g., a 360-degree scan, while maintaining the same angle. The 360-degree scan can be performed at a suitable resolution. In some implementations, the resolution may be 0.2 degrees such that about 1800 readings are obtained per beam in a 360-degree scan. Block 602 is followed by block 604.

In block 604, a particular LiDAR beam is selected. Block 604 is followed by block 606.

In block 606, readings for the selected LiDAR beam are obtained, e.g., observations from the scan performed in block 602 are obtained. Each reading may be in a triple of the form (dᵢ, ϕᵢ, θ), where θ is the angle that the beam makes to the horizontal (e.g., the ground), ϕᵢ is the sweep angle for the reading, and dᵢ indicates that there is an obstruction at that distance, e.g., an obstruction from which light of the beam was reflected. For example, 1800 readings may be obtained for i=1 to 1800, with a resolution of 0.2 degrees such that the values ϕᵢ change by 0.2 degrees between successive readings. Block 606 is followed by block 608.

In block 608, respective x component (xᵢ) and y components (yᵢ) are calculated as xᵢ=dᵢ cos ϕᵢ and yᵢ=dᵢ sin ϕᵢ Block 608 is followed by block 610.

In block 610, averages of the x and y components are calculated. For example, these values can be calculated using formulae II-A and II-B. Block 610 is followed by block 612.

In block 612, x and y vectors are calculated. For example, x vector can be calculated using formula III and y vector can be calculated similarly. Block 612 is followed by block 614.

In block 614, a true angle α between the LiDAR beam and the light reflecting object is calculated. For example, the true angle α can be calculated using formula IV. Block 614 is followed by block 616.

In block 616, a beam-specific perpendicular distance (shortest distance) between the LiDAR sensor and the light reflecting object is calculated using the true angle α and average of the x and y components e.g., using formula V. Block 616 is followed by block 618.

In block 618, it is determined if there are additional beams for which the distance calculation is to be performed. For example, in some implementations, distance calculation may be performed for each beam of the LiDAR. In some implementations, distance calculation may be performed for a subset of beams, e.g., a single beam (e.g., the zero angle beam, the beam with the lowest angle, the beam with the highest angle, etc.); two or more beams (e.g., every alternate beam, etc.).

In some implementations, the selection of beams for distance calculation may be based on various factors. For example, such factors can include one or more of: a current angle of motion of the vehicle, e.g., whether the vehicle is moving on flat ground (utilize beam that are parallel or close to parallel), going upslope (utilize beams that are directed upwards), or going downslope (utilize beans that are directed downwards); the available battery and/or compute capacity of the vehicle (use more beams when battery/compute availability is high, omit certain beams when the battery/compute availability is low); the level of accuracy of measurement for the current context (e.g., can tolerate greater errors when the vehicle moves in a large open space whereas high accuracy is required in other contexts such as movement in a cramped corridor, docking to charging point, or navigating a lane). If it is determined that distance calculation is to be performed for another beam, block 618 is followed by block 604. Else, block 618 is followed by block 620.

In block 620, a distance between the vehicle and the light reflecting object is determined by aggregating beam-specific perpendicular distances as calculated in block 616. For example, to aggregate data from multiple beams (some of which may indicate a different value of distance), a weighted average of the distance may be obtained, where weight is determined based on the number of reflections (indicative of presence of an obstacle) for the individual beam. A higher number of reflections indicates that the beam hit the obstacle at multiple points and is thus weighted higher in the aggregation. Further, if a particular beam doesn't hit the obstacle (e.g., passes through a window or other opening), but other beams do, data from the particular beam is assigned zero weight (since there are no reflections).

Method 600 may be repeated any number of times as a vehicle moves in an environment. For example, method 600 may be performed at fixed time intervals, e.g., n times per second, n times per minute. In some implementations, the time interval at which method 600 is performed may be based on a speed of the vehicle that carries the LiDAR. In some implementations, the time interval at which method 600 is performed may be based on prior knowledge of the environment, e.g., whether the environment is a large empty space, a narrow corridor, etc.

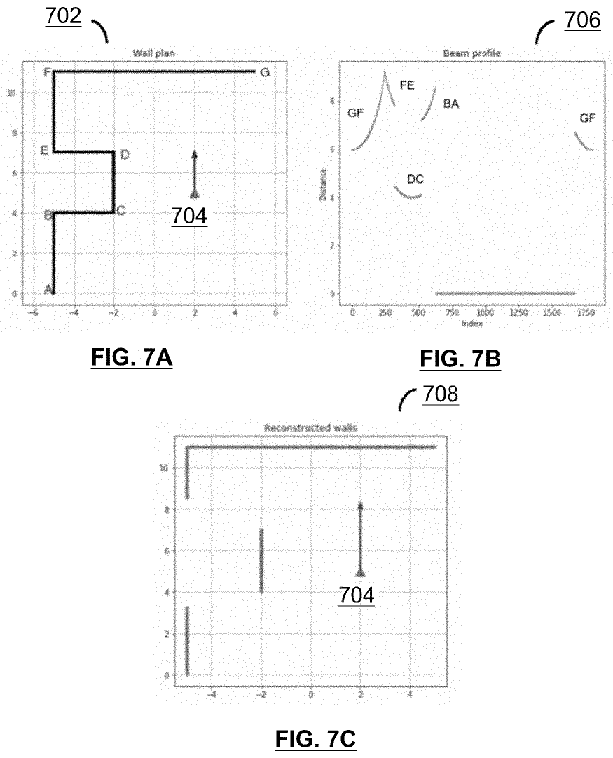

FIG. 7A illustrates an example environment 702 in which a vehicle 704 is located. As shown in FIG. 7A, environment 702 includes walls AB, BC, CD, DE, EF, and FG. Vehicle 704 has an onboard LiDAR. The zero-direction of the LiDAR points north, as shown. Further, as seen in FIG. 7A, vehicle 704 is currently located at the coordinate (2, 5). For ease of illustration, wall segments AB, CD, and EF are shown oriented along the y-axis and wall segments BC, DE, and FG are shown oriented along the x-axis. In various environments, the walls can have arbitrary orientations and/or heights.

The on-board LiDAR performs a complete counterclockwise sweep. Over the course of a single sweep, 1800 readings are obtained per beam. Walls being solid light reflecting objects, the beam is reflected whenever it hits a wall, while beams that are directed towards other portions of the environment are not reflected. For a given wall segment, the reflected beam distance is inversely proportional to cos θ where θ is the angle of the beam with respect to the ground.

FIG. 7B shows a beam profile 706 obtained during a complete sweep of a single beam from a LiDAR of vehicle 704. As can be seen, each wall segment is represented by a set of contiguous points that are obtained from reflections of the beam as measured by the LiDAR. The x-axis of FIG. 7B shows the index (which is based on the sweep angle), beginning at index=0 (corresponding to the zero-direction of the LiDAR) and ending at index=1800, indicating the completion of a 360-degree sweep. The y-axis shows the distance (as measured by the LiDAR, not the perpendicular or shortest distance) of each measured point from the LiDAR. The order of the points corresponding to a wall can wrap around, e.g., the wall FG of FIG. 7A is detected as 2 different segments GF as seen in FIG. 7B since wall FG is observed at the start of the rotation of the beam as well as when the rotation is nearing completion.

As can be seen in FIG. 7B, walls BC and DE are not detected by the LiDAR in its current position. The 2D projection of each wall is the collection of points from which the LiDAR detected a reflection, e.g., (xᵢ, yᵢ) where i=1, 2, . . . , N. Using techniques described above with reference to FIGS. 5A, 5B, and 6, the walls in the environment can be reconstructed. In particular, the perpendicular distance between vehicle 704 and each of the walls can be calculated based on the LiDAR readings.

It will be understood that in different real world environments, reflections can be detected from irregular surfaces. Further, different LiDAR beams having different angles θ may be detect different distances and/or walls. For example, a first beam directed towards the floor may detect a low wall, while a second beam directed higher may not detect the same wall, since there is no reflecting surface at the height at which the second beam intersects with the plane of the wall. In another example, e.g., when the wall has a window cut out, low and high beams may detect the wall, but beams of intermediate angles may not detect the wall. In this manner, by combining observations from individual LiDAR beams, robust estimation of walls and openings in the environment can be obtained. In practice, LiDAR readings may have a noise in measurements. Thus, for small sections of a wall, the LiDAR readings may be noisy.

In particular, to detect walls, a sliding window technique is used. For a given beam with a beam angle θ, slide a window of size N across the readings obtained for the beam. This is given by (dᵢ, ϕᵢ) for i=1, 2, . . . , N. The values can then be converted into 2D coordinates, denoted as (xᵢ, yᵢ) for i=1, 2, . . . , N. To make the values scale invariant, translate this windowed region to the original by using the formula:

\hat{x}=Σx|ᵢ/N and y̅=Σyᵢ/N

Now, for i=1, 2, . . . , N, define the tuple

(\hat{x}ᵢ,ŷᵢ)=(xᵢ−x̅,yᵢ=y̅)

In effect, the windowed region can be summarized as a matrix M, given by the formula:

$$M = [ \begin{matrix}{\hat{x}}_{1} & {\hat{x}}_{2} & ⋯ & {\hat{x}}_{N} \\ {\hat{y}}_{1} & {\hat{y}}_{2} & ⋯ & {\hat{y}}_{N}\end{matrix} ]$$

The singular value decomposition of MM^{T} is given by the formula:

σ₁u₁v₁^{T}+σ₂u₂^{T}v₂

where u₁ and u₂ correspond to the directions along which the data points lie. When the observed reflections are from a wall (straight line segment, since the points are collinear for a given beam angle), the first singular value σ₁ dominates the second singular value σ₂ by an order of magnitude. The values are used to determine whether the detected object is a one-dimensional object (e.g., a wall) or a two-dimensional object (e.g., a corner where two walls intersect, a circular pillar, etc.) In practice, setting the threshold value for σ₂ smaller than 0.05 enables robust wall detection. The use of a small threshold accounts for noise (inaccuracy) in the LiDAR readings. Singular value decomposition thus enables detection of wall surfaces while filtering out noise.

FIG. 7C shows reconstructed walls 708 based on data from an on-board LiDAR of vehicle 704. As can be seen, reconstructed walls correspond to walls AB, CD, EF and FG that are detected by reflections of the beam. It can also be seen that portions of walls EF and AB that are behind the wall CD are not detected. This occurs since the light beam directed towards these portions is reflected from the wall CD which is closer to the LiDAR.

The techniques of wall detection and distance calculation as described herein can be utilized to construct a map of an environment in which a vehicle is to navigate. For example, the vehicle can be placed in the environment and can detect walls and other objects in the environment. The vehicle can then navigate itself to various parts of the environment obtaining further LiDAR readings and detecting additional walls and/or rooms. The movement of the vehicle can be correlated with observed walls to construct a map of the environment. The map can be used in subsequent operation of the vehicle to automatically navigate the vehicle to various locations within the environment, e.g., a load pickup bay, a load drop-off bay, a charging point, a battery swap point, etc.

To construct the map, the vehicle is configured to traverse the entire environment in a mapping run. As the vehicle traverses the space, detected wall distances are recorded in a geo-referenced database. For example, the database can include a set of tuples, each tuple corresponding to a particular reference pose or location (including the position and orientation) of the vehicle.

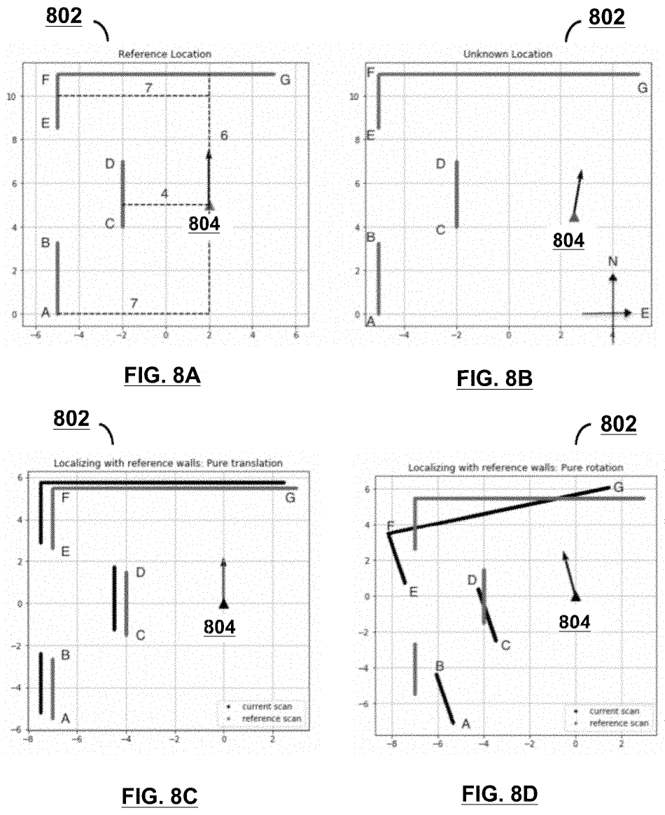

FIG. 8A illustrates a vehicle 804 at a reference location having coordinates (2, 5) in an environment 802. Table 1 below illustrates a tuple corresponding to the pose of vehicle 804 in environment 802.

TABLE 1

| Ref. Pose | Wall 1 | Wall 2 | Wall 3 | Wall 4 |
|---|---|---|---|---|
| (xᵣ, yᵣ) | (7, 90 deg) | (4, 90 deg) | (7, 90 deg) | (6, 0 deg) |
| (xₛ, yₛ) | . . . | . . . | . . . | . . . |

In Table 1, wall 1 corresponds to wall EF of FIG. 8A. As seen in the FIG. 8A, wall EF is at a perpendicular distance of 7 units and 90-degrees (in the counterclockwise direction) from the LiDAR zero direction. Similarly, wall 2 corresponds to wall CD with a distance of 4 units and angle of 90-degrees; wall 3 corresponds to wall AB with a distance of 7 units and angle of 90-degrees; and wall 4 corresponds to wall FG with a distance of 6 units and angle of 0 degrees. The number of walls detected and stored in the geo-referenced database can be chosen based on the computational complexity associated with determining pose and robustness in pose estimation. Robustness improves when a greater number of walls is used in pose determination; however, a greater number of walls increases computational complexity. A trade-off can be made based on the type of environment that the vehicle operates in.

The pose (location and orientation) of the vehicle in a known environment can be determined from the fixed walls in the environment that are detected by an onboard LiDAR of the vehicle by comparison with a known map of the environment, as stored in the geo-referenced database.

FIG. 8B shows vehicle 804 which is located at an unknown location in the environment 802. In this position, the vehicle has translated slightly southeast from the reference location of FIG. 8A. To localize the vehicle using the last known pose of the vehicle, the geo-referenced database is queried to obtain a nearest known reference pose. The distances and orientation to known walls are available based on LiDAR readings from the vehicle. The detected walls can be matched with the reference pose to determine the current pose of the vehicle. FIGS. 8C and 8D illustrate two types of change in location—pure translation where the vehicle is not in a reference location but the zero direction of the LiDAR is the same as the reference location and pure rotation where the vehicle is in the reference location, but the zero direction of the LiDAR is different, e.g., the vehicle is facing in a different direction.

In the case of pure translation, as seen in FIG. 8C, the vehicle has moved 0.5 units east and 0.25 units south, with the total south-east movement being from the reference coordinates (xᵣ,yᵣ) of FIG. 8A to the coordinates (xᵣ+0.5, yᵣ−0.25) of FIG. 8C. As a result of the movement, walls AB, CD, and EF are now at a distance of 7.5, 4.5, and 7.5 respectively. On the other hand, the wall FG is now at a distance of 6.25. Since there is no change in the orientation of the vehicle (zero direction the LiDAR remains the same as in the reference position), walls AB, CD, and EF are parallel and wall FG is perpendicular to the direction of the LiDAR zero.

As seen in FIG. 8C, the walls as detected after the movement of the vehicle (shown in black, current scan) are parallel to and shifted southeast from the reference walls (shown in gray, reference scan) and are farther away from the vehicle. Comparison of the detected walls with reference location therefore indicates that the vehicle is 0.5 units south and 0.5 units east of the reference position.

In practice, due to presence of measurement noise in the LiDAR readings as well as undulations on the walls, the relative movement of the vehicle can be averaged across multiple walls when determining the location of the vehicle.

In the case of pure rotation, as seen in FIG. 8D, the vehicle is in the same position, but has rotated 15 degrees counterclockwise, resulting in corresponding change in the zero direction of the LiDAR. Due to the rotation, the detected walls, as seen in the local frame of the LiDAR are rotated as well, as can be seen in FIG. 8D. The shortest distance from the vehicle to the wall FG is at an angle 15 degrees rotated clockwise from the new zero of the LiDAR. Similar to the pure translation case above, averaging across the change in orientation of the vehicle with reference to multiple reference walls can be performed when estimating the new pose of the vehicle.

In the cases of FIGS. 8C and 8D, a correspondence is established between walls detected from a current pose (location and orientation) of the vehicle and a known, prior pose, e.g., stored in the geo-referenced database. To establish accurate correspondence, threshold can be configured on the translation and rotation between successive scans as the vehicle moves. The thresholds can be chosen based on the maximum linear and angular velocity that the vehicle is configured for. Higher thresholds are used at higher speeds of motion of the vehicle, since the displacement and rotation of the vehicle is high.

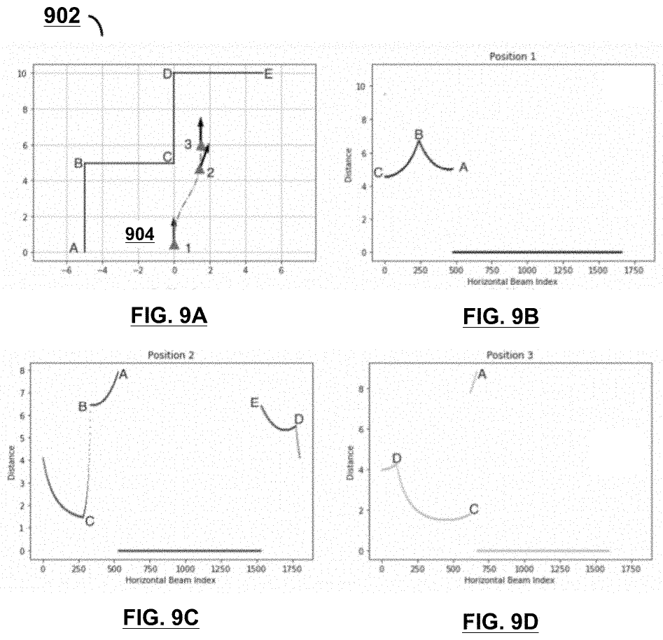

In some implementations, the current pose of a vehicle is determined from the walls that are detected, even in the absence of a reference map (geo-referenced database) that identifies the wall layout in the environment prior to the run of the vehicle. FIGS. 9A-9D illustrate the determination of vehicle pose in this situation.

As seen in FIG. 9A, vehicle 904 is positioned in environment 902 at an initial location 1, and subsequently, moves to location 2 followed by location 3. FIGS. 9B, 9C, and 9D show the detected walls from location 1, location 2, and location 3 respectively.

Consider that walls AB and BC are the walls that the vehicle is currently tethered to, e.g., the vehicle is navigating environment 902 based on its location with reference walls AB and BC. As seen in FIG. 9B, the onboard LiDAR of the vehicle detects walls AB, BC, and DE.

In location 1, the perpendicular distance to walls AB and BC is 5 units. As the vehicle moves to location 2, walls AB, BC, CD, and DE are all detected, as seen in FIG. 9B. It is recognized that the wall CD was not seen in the prior position. Also, since the new wall CD is parallel to wall AB, the orientation of the vehicle with respect to walls AB and CD is identical. As the distance of the vehicle from wall AB is known, the relative position of the new wall CD can be determined when it is initially detected. For example, when the vehicle is in location 2, as shown in FIG. 9B, the wall CD is about 1 unit to the east whereas wall AN is 7 units to the east of the vehicle.

When the vehicle moves to location 3, as shown in FIG. 9C, wall AB progressively disappears from the detected walls. However, the distance measured from the wall CD can be used to localize the vehicle. Similarly, the vehicle can be localized when wall BC gradually disappears between locations 1 and 3, by using the distance from wall DE to localize the vehicle.

While FIG. 9A shows walls that are oriented along the x or y direction, the described techniques can localize the vehicle using walls of arbitrary orientation and combinations. For example, real-world environments may include walls that are at angles of less than or greater than 90 degrees to other walls, can include wide open spaces with walls at great distances, etc.

The foregoing discussion of wall detection, distance measurement, and localization refers to vehicle movement in the x-y plane. However, real-world environments also require a vehicle to navigate in the z direction as well, e.g., up or down a ramp or other slope. Reference mapping in the x-y plane (which is likely the primary plane of vehicle movement) enables navigation with relatively low memory and processing requirements.

When features in the z-dimension are important for localization and navigation, several reference maps are constructed in the x-y plane, each corresponding to one or more beams of the LiDAR, each beam having a respective value of θ. The reference maps are each associated with a respective height.

A current scan of the LiDAR is then matched with each of the reference maps and a weighted pose is calculated. The individual weights decay or increase over time, depending on the richness of features in the corresponding position (e.g., features near the ground-level vs. features at greater heights). The weights can be normalized to the number of matches (matching walls) in the corresponding map. In effect, the collection of reference maps and corresponding weights together allow the available data (detected walls, with associated distances and height values) to be used effectively to determine vehicle pose. Based on navigation performance of the vehicle, the weights used for individual maps can be adjusted over time.

For example, when the vehicle is placed in a narrow aisle, with small objects, e.g., trolleys of height 4-6 feet are placed abutting the aisle, LiDAR beams of smaller elevation angles (closer to the ground) detect such objects and are accorded a higher weight. In another example, when the vehicle is placed in a wide open space, e.g., an open warehouse floor, with pillars in the far distance, LiDAR beams with higher elevation angles have a higher likelihood of detecting the pillars. Use of multiple two-dimensional maps at different height slices enables accurate localization of the vehicle in these different scenarios.

Further, as objects in an environment may vary over time (e.g., as trolleys are moved, boxes removed or placed, etc.) reference maps (as stored in the geo-referenced database) are updated with time. Further, during the course of operating the vehicle in the environment, it is possible that some portions of the environment are not visited.

Dynamic update of the reference map is performed so that such situations can be accommodated easily, by updating only those sub-maps that have changed. Denoting S as the set of sub-maps that are to be updated, a map update equation can be written as:

M(s,t)=(1−α)M(s,t−1)+αM_{new}(s)Vs in S

where α is the decay coefficient that specifies the rate at which the older map is to be updated, t refers to the current time, t−1 refers to a previous time of map update.

The foregoing discussion assumes that the vehicle is stationary (or has a slow speed) such that motion of the vehicle during a single 360-degree LiDAR sweep (frame) can be ignored when detecting walls, determining distances, and determining the pose of the vehicle. The calculations as explained earlier are relatively error-free when the motion of the vehicle in the time taken for a single sweep of the LiDAR is small and distances to walls are higher.

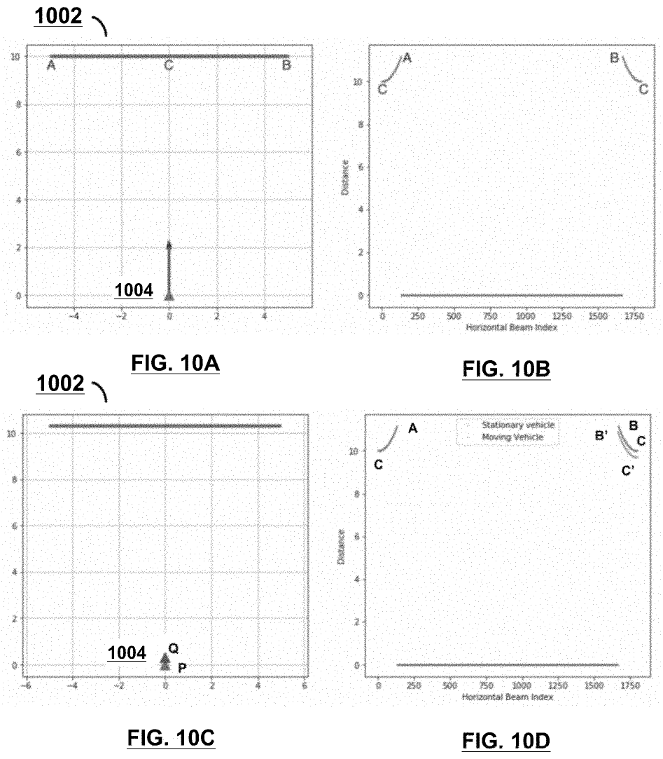

FIGS. 10A and 10B illustrate a first example of such a situation. As can be seen in FIG. 10A, vehicle 1004 is stationary at location (0,0) in environment 1002 during a single sweep of the LiDAR. For ease of illustration, environment 1002 is shown to include a single wall AB, with two segments AC and BC. As seen in FIG. 10B, a single counterclockwise sweep of the LiDAR results in detection of wall segments CA (in the initial portion of the sweep, index numbers<250) and BC (in the final portion of the sweep, index numbers>1500). The vehicle is closest to point C (as seen in FIG. 10B) and the distance to the wall increases as the scan moves from C to A, and then decreases as the scan moves from B to C. The perpendicular distance is the distance to point C, which is constant over the entire scan.

FIGS. 10C and 10D illustrate a second example of such a situation. As can be seen in FIG. 10C, vehicle 1004 moves north from point P (0,0) to point Q during a single sweep of the LiDAR in environment 1002. For ease of illustration, environment 1002 is shown to include a single wall AB, with two segments AC and BC. As seen in FIG. 10C, a single counterclockwise sweep of the LiDAR results in detection of wall segments CA (in the initial portion of the sweep, index numbers<250) and BC (in the final portion of the sweep, index numbers>1500). The vehicle is closest to point C (as seen in FIG. 10C) and the distance to the wall increases as the scan moves from C to A, and then decreases as the scan moves from B to C. The perpendicular distance is the distance to point C. However, the vehicle moves from point P which is close to the location of the vehicle during the initial portion of the sweep during which wall segment CA is detected, to point Q which is the location close to the vehicle during the final portion of the sweep during which wall segment BC is detected. As a result, the measured segment B′ C′ is closer to the vehicle, resulting in an estimate of perpendicular distance from the latter portions of the sweep that is less than that from the initial portion of the sweep.

While not compensating for change in vehicle location during a LiDAR sweep can be acceptable (and computationally less intensive) for slow speed vehicles, where the distance transitioned by the vehicle during the sweep is small compared to the distance from walls, it may not be acceptable when accurate location determination is necessary, e.g., to dock a vehicle to a charging port, or when, during a sweep, when the vehicle covers a distance of a similar magnitude as the distance to one or more walls.

In some implementations, motion compensation is performed by generating a prediction of the next velocity state of the vehicle. In particular, a Kalman filter can be applied to predict the next velocity state based on commands given to the vehicle power source (motor). The prediction can be corrected by measuring the wheel encoder and accelerometer.

In some implementations, the LiDAR on-board a vehicle may include 16 beams (16 values of θ) and may perform a sweep in 100 ms. The readings thus obtained include 29,500 data points, corresponding to about 1810 azimuth values (horizontal beam positions—angles ϕ) for each elevation (angles θ). In these implementations, processing every LiDAR frame (where a frame refers to readings from a single LiDAR sweep) can be computationally expensive.

In some implementations, the computer on-board the vehicle can be configured to exploit temporal and/or spatial redundancy by using a sleep mode or a smart driving mode, as described below:

Sleep Mode:

Vehicle stationarity can be detected from wheel encoder readings, after monitoring the filtered measurements for at least a threshold time duration, to avoid hysteresis and to dampen sensor noise. When the vehicle is detected to be stationary, the on-board computing device that processes signals from the LiDAR is switched to sleep mode. In the sleep mode, a LiDAR frame is processed once every T seconds, e.g., as needed for vehicle functions such as health diagnostics check. The duty cycle (the value of T) can be increased progressively if the vehicle remains stationary for a long duration of time.

Smart Driving Mode:

Motor control commands and the reference trajectory of the vehicle may be known ahead of time, e.g., when the vehicle is navigating a route towards a known destination such as a charging point, a load/unload point, etc. A driving sector where the vehicle is likely to traverse over the next few, e.g., 5, 10, etc. LiDAR frames can be predicted with minimal processing. The prediction, along with a configuration height for safe navigation, is used to determine a cone of interest. The cone of interest can be converted to a binary mask that is applied to the LiDAR readings in the next frame. In this manner, processing (wall detection, distance computation, pose determination, etc.) can be restricted to a smaller section that corresponds to the anticipated driving cone.

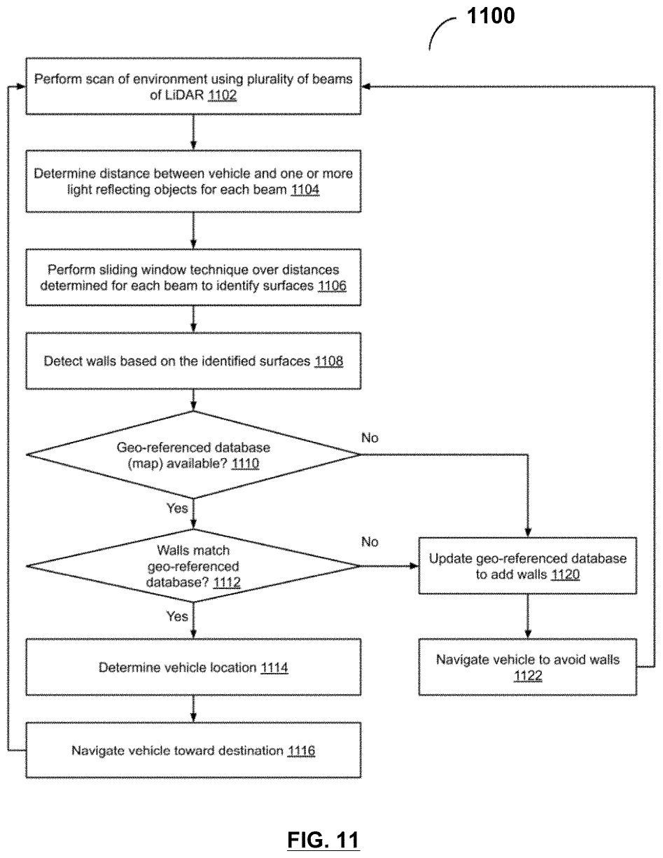

FIG. 11 illustrates an example method 1100 to determine the location of a vehicle and navigate the vehicle to a destination

Method 1100 begins at block 1102 where a LiDAR sensor on-board a vehicle is activated to perform a scan of the environment using a plurality of light beams, e.g., 16 beams. In some implementations, the plurality of light beams may span a total angle of 30 degrees. For example, the LiDAR sensor may be mounted at the top of a vehicle. The plurality of light beams may each have a respective angle with respect to the ground. Each beam may be rotated to perform a scan of the surroundings of the vehicle, e.g., a 360-degree scan, while maintaining the same angle. The 360-degree scan can be performed at a suitable resolution. In some implementations, the resolution may be 0.2 degrees such that about 1800 readings are obtained per beam in a 360-degree scan. Block 1102 is followed by block 1104.

In block 1104, a distance between the vehicle and one or more light reflecting objects in the environment is determined for each beam of the LiDAR. For example, the distance may be determined using the method described with reference to FIG. 6 above. Block 1104 is followed by block 1106.

In block 1106, a sliding window technique is performed to detect surfaces in the environment. In the sliding window technique, the distance determined between the vehicle and each of the one or more obstacles for each beam is analyzed to identify whether the beam was reflected off of a surface and a distance to the surface. For example, if there is a wall ahead of the LiDAR (θ=0 degrees and in the range of ϕ=0 degrees to ϕ=50 degrees) at a distance of 5 meters, the surface can be detected as present at a distance of 5 meters away and having a width determined based on the change in sweep angle from 0 to 50 degrees. Similar calculations can be performed for other beams, each having a respective value of θ. Block 1106 is followed by block 1108.

In block 1108, the surfaces detected for the selected LiDAR beams are combined. For example, if a surface is detected by three beams at different values of θ (e.g., 0-degrees, 10-degrees, and 20-degrees), the surface may be determined to be a contiguous wall. If an intermediate beam (having an intermediate value of θ) fails to detect a surface, that portion of the wall may be characterized as an opening. By combining observations from multiple beams, the detected surfaces are combined to construct a two-dimensional wall (possibly with openings). One or more walls in the environment can be detected based on the 360-degree rotation (change in ϕ) of each beam and the plurality of beams (with different angles θ). It will be understood that a wall refers to any reflective surface, e.g., a physical wall, a curtain, a box or other object, etc. that reflects light from the LiDAR. Block 1108 is followed by block 1110.

In block 1110, it is determined if a geo-referenced database (map) of the environment was previously constructed and is available. For example, the database may be stored in a local memory or storage device of the vehicle. If a map is available, block 1110 is followed by block 1112; else, block 1110 is followed by block 1122.

In block 1112, the detected walls are compared with stored walls in the geo-referenced database. If a match is detected, block 1112 is followed by block 1114; else, block 1112 is followed by block 1120.

In block 1114, the location of the vehicle is determined based on the matched walls. Determining location includes determining the position and orientation of the vehicle, together referred to as the pose, with reference to the map. Block 1114 is followed by block 1116.

In block 1116, the vehicle is navigated toward a destination. For example, the destination can include a loading or unloading point, a charging point, a battery swap point, etc. in the environment. Based on the detected location, the direction (and velocity) of the vehicle is controlled to navigate the vehicle to the destination. For example, if the vehicle is detected in a large empty space and oriented toward a destination, an acceleration command can be provided to increase a speed of the vehicle. If the vehicle is oriented in a different direction, a rotation command can be provided to rotate the vehicle toward the destination. Block 1116 may be followed by block 1102 to obtain further LiDAR readings.

When no geo-referenced database (map) is available (e.g., during an initial, mapmaking run of the vehicle), or when the detected walls don't match the geo-referenced database (e.g., due to changes in the environment), block 1120 may be performed to update the geo-referenced database. Block 1120 is followed by block 1122. In block 1120, the geo-referenced database is updated to add the detected walls. In some implementations, e.g., where no geo-referenced database is used, block 1120 may not be performed.

In block 1122, the vehicle is navigated to avoid the detected walls. For example, the vehicle may be moved in a particular direction. Block 1122 is followed by block 1102, where another LiDAR measurement is obtained.

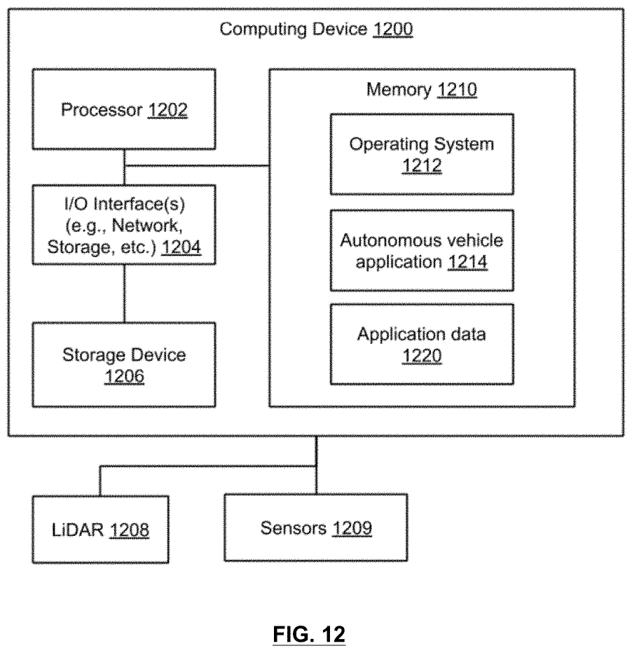

FIG. 12 is a block diagram of an example computing device 1200 which may be used to implement one or more features described herein. In one example, device 1200 may be used to implement a computer device, e.g., an autonomous vehicle navigation device, and perform appropriate method implementations described herein. Device 1200 can be any suitable computer system, server, or other electronic or hardware device. For example, the device 1200 can be an on-board computer, a portable computer, a mobile device, or computing device. In some implementations, device 1200 includes a processor 1202, input/output (I/O) interface 1204, one or more storage devices 1206, and a memory 1210. Device 1200 may be coupled to a LiDAR 1208. In some implementations, device 1200 may also be coupled to one or more sensors 1209 (e.g., velocity sensor, light sensor, depth sensor, weight sensor, etc.)

Processor 1202 can be one or more processors and/or processing circuits to execute program code and control basic operations of the device 1200. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 1210 is typically provided in device 1200 for access by the processor 1202 and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 1202 and/or integrated therewith. Memory 1210 can store software operating on the server device 1200 by the processor 1202, including an operating system 1212, an autonomous vehicle application 1214, and application data 1220. In some implementations, autonomous vehicle application 1214 can include instructions that enable processor 1202 to perform the functions described herein, e.g., some or all of the methods of FIG. 6 and FIG. 11. Memory 1210 and/or storage device 1206 also stores application data 1220, e.g., a geo-referenced database or map.

Any of software in memory 1210 can alternatively be stored on any other suitable storage location or computer-readable medium. In addition, memory 1210 (and/or other connected storage device(s)) can store other instructions and data used in the features described herein. Memory 1210 and any other type of storage (magnetic disk, optical disk, magnetic tape, or other tangible media) can be considered “storage” or “storage devices.”

I/O interface 1204 can provide functions to enable interfacing the computing device 1200 with other systems and devices. For example, network communication devices, external storage devices, and other input/output devices can communicate via interface 1204. In some implementations, the I/O interface 1204 can connect to interface devices including input devices (keyboard, pointing device, touchscreen, microphone, camera, scanner, etc.) and/or output devices (display device, speaker devices, printer, motor, etc.).

Storage device 1206 is one example of a storage device, e.g., a solid-state storage device, a hard disk drive, etc. that can be used by operating system 1212 and/or application 1214. Storage device 1206 is a direct attached storage device, e.g., coupled to processor 1202 and directly controlled by processor 1202. Processor 1202 is coupled to I/O interface(s) 1204, storage device 1206, and memory 1210 via local connections (e.g., a PCI bus, or other type of local interface) and/or via networked connections.

For ease of illustration, FIG. 12 shows one block for each of processor 1202, I/O interface 1204, storage device 1206, and memory 1210 with software blocks 1212, 1214, and 1220. These blocks may represent one or more processors or processing circuitries, operating systems, memories, I/O interfaces, applications, and/or software modules. In other implementations, device 1200 may not have all of the components shown and/or may have other elements including other types of elements instead of, or in addition to, those shown herein.

One or more methods described herein (e.g., method 600 or method 1100) can be implemented by computer program instructions or code, which can be executed on a computer. For example, the code can be implemented by one or more digital processors (e.g., microprocessors or other processing circuitry), and can be stored on a computer program product including a non-transitory computer-readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc.

The program instructions can also be contained in, and provided as an electronic signal, for example in the form of software delivered from a server (e.g., a distributed system and/or a cloud computing system). Alternatively, one or more methods can be implemented in hardware (logic gates, etc.), or in a combination of hardware and software. Example hardware can be programmable processors (e.g. Field-Programmable Gate Array (FPGA), Complex Programmable Logic Device), general purpose processors, graphics processing units (or GPUs) Application Specific Integrated Circuits (ASICs), and the like. One or more methods can be performed as part of or component of an application running on the system, or as an application or software running in conjunction with other applications and operating system.

One or more methods described herein can be run in a standalone program that can be run on any type of computing device, a program run in a web browser, a server application that executes on a single computer, a distributed application that executes on multiple computers, etc. In one example, a client/server architecture can be used, e.g., a mobile computing device (as a client device) sends user input data to a server device and receives from the server the final output data for output (e.g., for display). In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations. Note that the functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

1. A computer-implemented method to determine a distance between a LiDAR sensor and a light-reflecting object, the method comprising:
obtaining a plurality of readings (n) from a LiDAR sensor, wherein each reading includes a distance value (dᵢ) and an angle value (ϕᵢ), wherein the distance value is indicative of a distance of the LiDAR sensor from the light-reflecting object and the angle value is indicative of an angle between a zero angle of the LiDAR sensor and an angle at which a LiDAR beam hits the light-reflecting object;
calculating a respective x-component (xᵢ) and a respective y-component (yᵢ) for each reading;
calculating average of the x-components (x_hat) and average of the y-components (y_hat);
determining an x-vector (x′) wherein the x-vector has n components and wherein an ith component of the x-vector equals xᵢ−x_hat;
determining a y-vector (y′) wherein the y-vector has n components and wherein an ith component of the y-vector equals yᵢ−y_hat;
determining a true angle (α) between the zero angle of the LiDAR sensor and the light-reflecting object by using the formula:
tan 2α=2x′^{T}y′/x′^{T}x′−y′^{T}y′; and
determining a perpendicular distance (d) between the LiDAR sensor and the light-reflecting object by using the formula:
d=x_hat*cos α+y_hat*sin α.

2. The computer-implemented method of claim 1, wherein the LiDAR sensor emits the LiDAR beam at a fixed angle (θ) with a sweep angle (ϕ) of 360 degrees and wherein each reading is obtained 0.2 degrees apart from an immediately previous reading.

3. The computer-implemented method of claim 1, wherein the LiDAR sensor is part of a moving vehicle, and wherein the plurality of readings are obtained during movement of the vehicle.

4. The computer-implemented method of claim 3, wherein the plurality of readings are obtained in a time-period during which a distance covered by the vehicle is less than one-tenth of the perpendicular distance (d) between the LiDAR sensor and the light-reflecting object.

5. A method to calculate a distance between a vehicle and a vertical surface, the method comprising:
obtaining, using a LiDAR sensor mounted on the vehicle, a plurality of observations each comprising an estimated distance (dᵢ) between the vehicle and the vertical surface and an angle (ϕᵢ) of the LiDAR sensor;
calculating respective x (xᵢ) and y (yᵢ) components based on each of the plurality of observations;
calculating a mean value of the x and y components (x_hat and y_hat);
determining x and y vectors, wherein each vector has a plurality of components, each component corresponding to a respective observation of the plurality of observations;
calculating a true angle (α) between the LiDAR sensor and the vertical surface based on the x and y vectors; and
calculating the distance (d) based on the true angle and the mean value of the x and y components respectively.

6. The computer-implemented method of claim 5, wherein the LiDAR sensor emits a LiDAR beam at a fixed angle (θ) with a sweep angle (ϕ) of 360 degrees and wherein each observation is obtained 0.2 degrees apart from an immediately previous observation.

7. The computer-implemented method of claim 5, wherein the LiDAR sensor is part of a moving vehicle, and wherein the plurality of observations are obtained during movement of the vehicle.

8. The computer-implemented method of claim 7, wherein the plurality of observations are obtained in a time-period during which a distance covered by the vehicle is less than one-tenth of the perpendicular distance (d) between the LiDAR sensor and the vertical surface.

9. A computer-implemented method comprising:
performing scan of an environment using a plurality of beams of a LiDAR sensor on-board a vehicle;
determining, for each beam of the LiDAR, a distance between the vehicle and one or more light reflecting objects in the environment;
performing a sliding window technique to identify one or more surfaces in the environment;
detecting one or more walls in the environment based on the one or more surfaces; and
navigating the vehicle based on the detected one or more walls.

10. The computer-implemented method of claim 6, further comprising:
determining if a map of the environment is available;
if it is determined that the map is available, determining whether the one or more walls match the map; and
if it is determined that the one or more walls match the map, determining a location of the vehicle in the environment, wherein navigating the vehicle is based on the location of the vehicle and a destination location, wherein the destination location is stored in the map.

11. The computer-implemented method of claim 7, wherein if it is determined that the one or more walls do not match the map, updating the map to the add the one or more walls to the map.

12. The computer-implemented method of claim 7, wherein if it is determined that the map of the environment is not available, updating the map to the add the one or more walls to the map.

13. The computer-implemented method of claim 7, wherein navigating the vehicle comprises guiding movement the vehicle to avoid the one or more walls.

14. A vehicle comprising:
a light detection and ranging (LiDAR) sensor;
a motor; and
an on-board computer coupled to the LiDAR sensor and configured to control the motor, wherein the on-board computer includes:
a hardware processor; and
a memory with instructions stored thereon that, when executed by the hardware processor, cause the hardware processor to perform operations comprising:
performing scan of an environment using a plurality of beams of the LiDAR sensor;
determining, for each beam of the LiDAR, a distance between the vehicle and one or more light reflecting objects in the environment;
performing a sliding window technique to identify one or more surfaces in the environment;
detecting one or more walls in the environment based on the one or more surfaces; and
navigating the vehicle based on the detected one or more walls.

15. The vehicle of claim 14, wherein the operations further comprise:
determining if a map of the environment is available;
if it is determined that the map is available, determining whether the one or more walls match the map; and
if it is determined that the one or more walls match the map, determining a location of the vehicle in the environment, wherein navigating the vehicle is based on the location of the vehicle and a destination location, wherein the destination location is stored in the map.

16. The vehicle of claim 15, wherein if it is determined that the one or more walls do not match the map, the operations further comprise updating the map to the add the one or more walls to the map.

17. The vehicle of claim 15, wherein if it is determined that the map of the environment is not available, the operations further comprise updating the map to the add the one or more walls to the map.

18. The vehicle of claim 15, wherein navigating the vehicle comprises guiding movement the vehicle to avoid the one or more walls.
